(19) United States
(12) Patent Application Publication
(10) Pub. No.: US 2019/0226668 A1
(43) Pub. Date: Jul. 25, 2019

(54) RETURN-TYPE WIRING STRUCTURE HAVING MULTIPLE DEVICES AND UNITS CAPABLE OF BEING FLEXIBLY INCREASED AND DECREASED

(71) Applicant: Huawang LIU, Bengbu (CN)

(72) Inventor: Huawang LIU, Bengbu (CN)

(21) Appl. No.: 16/002,998

(22) Filed: Jun. 7, 2018

(30) Foreign Application Priority Data
Jan. 22, 2018 (CN) 201810060449.5

(51) Int. Cl. F21V 23/00; F21S 4/10; H05B 37/03; H05B 33/08

(52) U.S. Cl. CPC F21V 23/002; F21S 4/10; F21W 2121/04; H05B 33/0848; H05B 37/036; H05B 37/032

(57) ABSTRACT

A return-type wiring structure having multiple devices and units capable of being flexibly increased and decreased comprising a plurality of light-emitting devices or illuminating devices, a power plug or an input terminal, and a power socket or an output terminal; the plurality of light-emitting devices or illuminating devices are divided into a plurality of collection units; each collection unit comprises at least two light-emitting devices or illuminating devices; the plurality of light-emitting devices or illuminating devices of each collection unit are first connected in parallel, and then the plurality of collection units are connected in series, thereby forming a total connection unit.

### TECHNICAL FIELD OF THE INVENTION

The present invention relates to a wiring structure of light-emitting devices or illuminating devices, and more particularly, to a return-type wiring structure having multiple devices and units capable of being flexibly increased and decreased, which not only allows the number of the light-emitting devices or illuminating devices to be freely increased or decreased according to the actual requirement, but achieves a stable voltage and smooth operation of the whole system even if one or more devices fail during the operation.

### BACKGROUND OF THE INVENTION

With technological progress, illuminating devices and light-emitting devices have been widely applied to various fields in people's daily life. Illuminating devices can supply lighting for activities such as reading, working, studying and production, and lighting-emitting devices can be used as working-state indicators, decorative lights of Christmas trees or crafts, and light sources of advertising lamp boxes or electronic signboards. In the prior art, when a plurality of light-emitting devices or illuminating devices are connected, for instance, when a plurality of LED lamp beads are connected in series or parallel to form a Christmas decorative lamp string, shortcomings of the traditional single connection method can be obvious. In a traditional parallel-connection structure, all devices are respectively connected to a power supply lead in parallel, and this inevitably causes a voltage reduction. However, when a plurality of devices are connected in series, and one of the series-connected devices fail, the voltage of other operating devices can immediately rise so that the load can be increased. As a result, the functional life of other devices can be sharply shortened, or even worse, the failure of the whole lamp string can be caused. As the traditional connection method of light-emitting devices or illuminating devices has shortcomings such as unreasonable wiring connection, unsafe use and unstable operation, it's urgent for those skilled in this field to develop a novel wiring structure.

### SUMMARY OF THE INVENTION

The purpose of the present invention is to solve the shortcomings in the prior art by providing a return-type wiring structure having multiple devices and units capable of being flexibly increased and decreased, which not only allows the number of the light-emitting devices or illuminating devices to be freely increased or decreased according to the actual requirement, but achieves a stable voltage and smooth operation of the whole system even if one or more devices fail during the operation.

To achieve the above purpose, the present invention adopts the following technical solution:

A return-type wiring structure having multiple devices and units capable of being flexibly increased and decreased comprising a plurality of light-emitting devices or illuminating devices, a power plug or an input terminal, and a power socket or an output terminal; the plurality of light-emitting devices or illuminating devices are divided into a plurality of collection units; each collection unit comprises at least two light-emitting devices or illuminating devices; the plurality of light-emitting devices or illuminating devices of each collection unit are connected in parallel first, and then the plurality of collection units are connected in series, thereby forming a total connection unit; the first collection unit of the total collection unit is electrically connected to the power plug or input terminal, and the last collection unit is electrically connected to the power socket or output terminal; the power plug or input terminal is connected to the power socket or output terminal through a positive electrode connecting wire and a negative electrode connecting wire; one end of the positive electrode connecting wire is connected between the positive electrode of the power plug or input terminal and the first collection unit; and the other end of the positive electrode connecting wire is electrically connected to the power socket or output terminal; one end of the negative electrode connecting wire is electrically connected to the negative electrode of the last collection unit, and the other end of the negative electrode connecting wire is electrically connected to the power plug or input terminal.

In another aspect of the present invention, the light-emitting device or illuminating device can be an illuminating bulb, an LED lamp, an LED decorative lamp or a lamp bead.

In another aspect of the present invention, in the collection units, the positive electrodes of the plurality of light-emitting devices or illuminating devices are sequentially connected in parallel, and the negative electrodes of the plurality of light-emitting devices or illuminating devices are sequentially connected in parallel. The positive electrode of the first light-emitting device or illuminating device in the first collection unit is electrically connected to the positive electrode of the power plug or input terminal, and the negative electrode of the last light-emitting device or illuminating device of the last collection unit is electrically connected to the negative electrode connecting wire.

In another aspect of the present invention, in the total collection unit, all collection units are connected in series through series-connecting the negative electrode of the last light-emitting device or illuminating device of each collection unit with the positive electrode of the first light-emitting device or illuminating device of another collection unit.

In another aspect of the present invention, the operating voltage of each collection unit is the operating voltage of each light-emitting device or illuminating device, and the total operating voltage of the total collection unit is the sum of the operating voltages of all collection units.

In another aspect of the present invention, in the plurality of light-emitting devices or illuminating devices of the connection units, the positive electrode of one light-emitting device or illuminating device is electrically connected to the negative electrode of another light-emitting device or illuminating device, and the negative electrode of one light-emitting device or illuminating device is electrically connected to the positive electrode of another light-emitting device or illuminating device. The positive electrode of the first light-emitting device or illuminating device of the first collection unit is electrically connected to the positive electrode of the power plug or input terminal, and the negative electrode of the last light-emitting device or illuminating device of the last collection unit is electrically connected to the negative electrode connecting wire.

In another aspect of the present invention, in the total collection unit, the positive electrode of the last light-emitting device or illuminating device of the first collection unit is connected to the positive electrode of the first light-emitting device or illuminating device of the second collection unit in series, and the negative electrode of the last light-emitting device or illuminating device of the second collection unit is connected to the negative electrode of the first light-emitting device or illuminating device of the third collection unit. Through alternately series-connecting the positive electrode of the last light-emitting device or illuminating device of each collection unit with the positive electrode of the first light-emitting device or illuminating device of another collection unit, and series-connecting the negative electrode of the last light-emitting device or illuminating device of each collection unit with the negative electrode of the first light-emitting device or illuminating device of another collection unit, the plurality of collection units can be connected in series to form the total collection unit.

In another aspect of the present invention, the operating voltage of each collection unit is the same as the operating voltage of each light-emitting device or illuminating device, and the total operating voltage of the total collection unit is the sum of the operating voltages of all collection units.

In another aspect of the present invention, when the number of the collection units is increased from N to N+1, the total operating voltage of the total connection unit is N+1 times that of the operating voltage of a single light-emitting device or illuminating device, and when the number of the collection units is decreased from N to N−1, the total operating voltage of the total connection unit is N−1 times that of the operating voltage of a single light-emitting device or illuminating device.

In another aspect of the present invention, in each collection unit, when the number of the light-emitting devices or illuminating devices is increased from N to N+1, the operating voltage of the collection unit is the same as the operating voltage of each light-emitting device or illuminating device, and when the number of the light-emitting devices or illuminating device is decreased from N to N−1, the operating voltage of the collection unit is the same as the operating voltage of each light-emitting device or illuminating device.

Compared with the prior art, the present invention has the following advantages: The present invention allows a plurality of light-emitting devices or illuminating devices that are used in combination to be divided into a plurality of collection units. The plurality of light-emitting devices or illuminating devices of each collection unit is connected in parallel. Thus, the operating voltage of each collection unit can be kept unchanged when the number of light-emitting devices or illuminating devices is increased or decreased. Meanwhile, a plurality of collection units are connected in series, enabling the number of the light-emitting devices or illuminating devices to be freely increased or decreased according to actual need. Thus, the total operating voltage can be stably controlled. When one or more devices fail, the circuit can be protected from being damaged due to the increased load of other devices. Furthermore, the return-type wiring structure of the present invention is directly connected to the power plug/input terminal and the power socket/input terminal, greatly simplifying the circuit structure while achieving a stable operating voltage. Therefore, the failure caused by excessive connection points can be solved. According to the present invention, the number of the collection units can be increased according to the actual need so that the requirement of using multiple devices in combination (e.g., Christmas decorative lamp strings) can be satisfied.

### BRIEF DESCRIPTION OF THE DRAWINGS

To clearly expound the technical solution of the present invention, the drawings and embodiments are hereinafter combined to illustrate the present invention. Obviously, the drawings are merely some embodiments of the present invention and those skilled in the art can associate themselves with other drawings without paying creative labor.

FIG. 1 is a circuit schematic diagram of embodiment 1 of the present invention;

FIG. 2 is a circuit schematic diagram of embodiment 2 of the present invention;

### DETAILED DESCRIPTION OF THE INVENTION

Drawings and detailed embodiments are combined hereinafter to elaborate the technical principles of the present invention.

A return-type wiring structure having multiple devices and units capable of being flexibly increased and decreased comprises a plurality of light-emitting devices or illuminating devices 10, a power plug or an input terminal 20, a power socket or an output terminal 30, a positive electrode connecting wire 41 and a negative electrode connecting wire 42.

### Embodiment 1

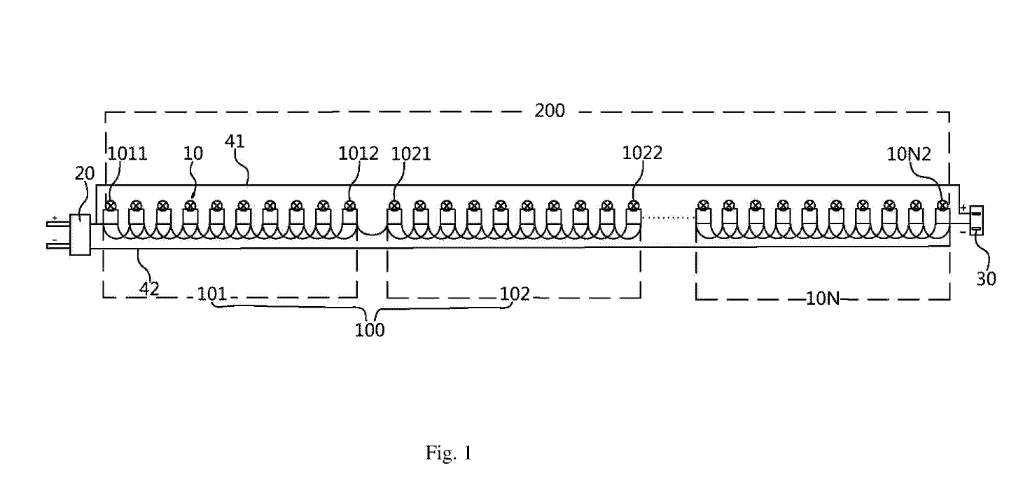

As shown in FIG. 1, the return-type wiring structure having multiple devices and units capable of being flexibly increased and decreased of the present invention comprises a plurality of light-emitting devices or illuminating devices 10, a power plug or an input terminal 20, and a power socket or an output terminal 30. The aforesaid light-emitting devices or illuminating devices 10 can be any known light-emitting devices or illuminating devices (e.g., illuminating bulbs, LED lamps, LED decorative lamps for Christmas trees or lamp beads). In this embodiment, LED lamp beads used for Christmas trees are taken as examples of the light-emitting devices or illuminating devices. Similarly, the power plug or input terminal 20 can be any known power plug or input terminal, and the power socket or output terminal 30 can be any known power socket or output terminal. In this embodiment, the power plug and the power socket are taken as examples.

As shown in FIG. 1, the aforesaid plurality of light-emitting devices or illuminating devices 10 are divided into a plurality of collection units 100 numbered from 101-10N. Each collection unit 100 comprises at least two light-emitting devices or illuminating devices 10. In this embodiment, the plurality of LED lamp beads 10 are divided into two collection units 101 and 102. Each collection unit 100 comprises 10 LED lamp beads 10. Certainly, the number of the LED lamp beads can be freely increased or decreased according to actual requirement, which is not restricted herein. As shown in FIG. 1, in the two collection units 101 and 102 of this embodiment, the 10 LED lamp beads 10 of each collection unit are connected in parallel. Specifically, in the collection units 101 and 102, the positive electrodes of the 10 LED lamp beads 10 of each collection unit are sequentially connected in parallel, and the negative electrodes of the 10 LED lamp beads 10 of each collection unit are sequentially connected in parallel. The positive electrode of the first LED lamp bead 1011 in the first collection unit 101 is electrically connected to the positive electrode of the power plug 20, and the negative electrode of the last LED lamp bead 1022 of the last collection unit 102 are electrically connected to the negative electrode connecting wire 42. In this embodiment, the operating voltage of each LED lamp bead 10 in the two collection units 101 and 102 is 3V. The operating voltage of each of the two collection units 101 and 102 is the same as that of the LED lamp bead 10, meaning that the operating voltage of each of the two collection units is 3V respectively. The total operating voltage of the total collection unit 200 is 2*3V=6V. Namely, the total operating voltage of the total collection unit 200 is 6V.

As shown in FIG. 1, in the total collection unit 200, the two collection units 101 and 102 are connected in series. Specifically, the negative electrode of the last LED lamp bead 1012 of the collection unit 101 is connected to the positive electrode of the first LED lamp bead 1021 of the collection unit 102 in series. Moreover, the last LED lamp bead 1022 of the collection unit 102 is electrically connected to the negative electrode of the power socket 30. Thus, the two collection units 101 and 102 are connected in series, thereby forming the total collection unit 200.

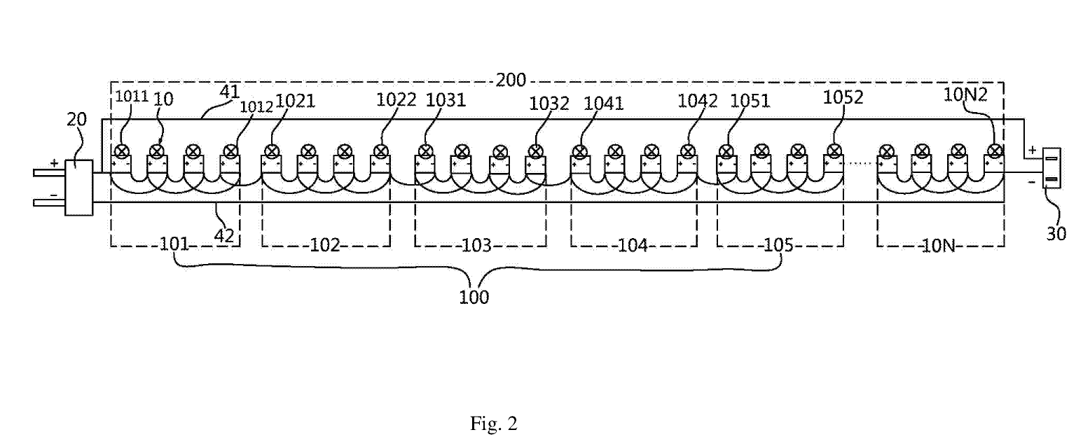

As shown in FIGS. 1-2, in the aforesaid collection units 101 and 102, the number of the LED lamp beads 10 can be flexibly increased or decreased according to the actual need. When the number of the LED lamp beads 10 is increased from 10 to 11, the operating voltages of the two collection units 101 and 102 are the same as that of each LED lamp bead 10. Namely, the operating voltage of each of the two collection units 101 and 102 is 3V. Further, when the number of the LED lamp beads 10 is decreased from 10 to 9, the operating voltage of each of the two collection units 101 and 102 is still 3V. According to the aforesaid wiring structure, the voltage variation of a certain collection unit can be avoided regardless of the increase or decrease of the LED lamp beads 10 in the collection unit. It means that even if one or more LED lamp beads 10 in a certain collection unit fail, the voltage and the load can be prevented from being affected. Thus, the wiring structure of the present invention is capable of ensuring the operating stability of the whole system.

As shown in FIG. 1 or 2, assuming that the number of the collection units 100 is increased from 10 to 11, the total operating voltage of the total collection unit 200 is 11*3V=33V. Likewise, assuming that the number of the collection units 100 is decreased from 10 to 9, the total operating voltage of the total collection unit 200 is 9*3V=27V. Namely, when the number of the collection units is increased or decreased, the total operating voltage of the total collection unit 200 can be increased or decreased by times. Therefore, according to the design voltage, the design requirement and the actual need can be satisfied by flexibly increasing or decreasing the number of the collection units.

### Embodiment 2

As shown in FIGS. 1-2, the basic structure of embodiment 2 is the same as that of embodiment 1. The difference between embodiments 1 and 2 is that the LED lamp beads 10 in the total collection unit 200 are divided into 5 collection units numbered from 101-105. Each collection unit 100 comprises 4 LED lamp beads 10. As shown in FIG. 2, in the five collection units 101-105 of this embodiment, the 4 LED lamp beads 10 of each collection unit are connected in parallel, More specifically, in the collection units 101-105, the positive electrode of one LED lamp bead 10 is connected to the negative electrode of another LED lamp bead 10 in parallel, and the negative electrode of one LED lamp bead 10 is connected to the positive electrode of another LED lamp bead 10 in parallel. Moreover, the positive electrode of the first LED lamp bead 1011 in the first collection unit 101 is electrically connected to the positive electrode of the power plug 20, and the negative electrode of the last LED lamp bead 1052 in the last collection unit 105 is electrically connected to the negative electrode connecting wire 42. In this embodiment, the five collection units 101-105 are connected in series, thereby forming the total collection unit 200. The first collection unit 101 of the total collection unit 200 is electrically connected to the power plug 20, and the last collection unit 10N is electrically connected to the negative electrode connecting wire 42.

As shown in FIG. 2, every two collection units 100 are connected in series. Specifically, the positive electrode of the last LED lamp bead 1012 of the first collection unit 101 is connected to the positive electrode of the first LED lamp bead 1021 of the second collection unit 102 in series. The negative electrode of the last LED lamp bead 1022 of the second collection unit 102 is connected to the negative electrode of the first LED lamp bead 1031 of the third collection unit 103 in series. The positive electrode of the last LED lamp bead 1032 of the third collection unit 103 is connected to the positive electrode of the first LED lamp bead 1041 of the fourth collection unit 104 in series. The negative electrode of the last LED lamp bead 1042 of the fourth collection unit 104 is connected to the negative electrode of the first LED lamp bead 1051 of the fifth collection unit 105 in series. Through alternately series-connecting the positive electrode of the last light-emitting device or illuminating device of one collection unit with the positive electrode of the first light-emitting device or illuminating device of the other collection unit, and alternately series-connecting the negative electrode of the last light-emitting device or illuminating device in one collection unit with the negative electrode of the first light-emitting device or illuminating device in the other collection unit, the five collection units can be connected in series to form the total collection unit 200.

As shown in FIG. 2, in this embodiment, the operating voltage of each LED lamp bead 10 in the five collection units 101-105 is 3V. The operating voltage of each of the five collection units 101 to 105 is the same as that of the LED lamp bead 10, meaning that the operating voltage of each of the five collection units is 3V. The total operating voltage of the total collection unit 200 is 5*3V=15V. The operating principle of embodiment 2 is the same as that of embodiment 1.

According to the present invention, a plurality of light-emitting devices or illuminating devices 10 that are used in combination are divided into a plurality of collection units 100. The plurality of light-emitting devices or illuminating devices 10 in the plurality of collection units 100 are connected in parallel, and the plurality of collection units are connection in series, thereby forming the total collection unit 200. The wiring structure of the present invention allows the number of the light-emitting devices or illuminating devices to be freely increased or decreased. Furthermore, when one or more devices in the wiring structure fail, the voltage and load of the system can be protected from being affected. Thus, even if one or more devices in the wiring structure having multiple devices (e.g. Christmas decorative lamps) fail, the whole system can normally operate, achieving a stable and smooth operation.

The description of above embodiments allows those skilled in the art to realize or use the present invention. Without departing from the spirit and essence of the present invention, those skilled in the art can combine, change or modify correspondingly according to the present invention. Therefore, the protective range of the present invention should not be limited to the embodiments above but conform to the widest protective range which is consistent with the principles and innovative characteristics of the present invention. Although some special terms are used in the description of the present invention, the scope of the invention should not necessarily be limited by this description. The scope of the present invention is defined by the claims.

1. A return-type wiring structure having multiple devices and units capable of being flexibly increased and decreased, comprising:
a plurality of light-emitting devices or illuminating devices,
a power plug or an input terminal, and
a power socket or an output terminal, wherein the plurality of light-emitting devices or illuminating devices are divided into a plurality of collection units, wherein each collection unit comprises at least two light-emitting devices or illuminating devices, wherein the plurality of light-emitting devices or illuminating devices of each collection unit are connected in parallel first, and then the plurality of collection units are connected in series, thereby forming a total connection unit, wherein the first collection unit of the total collection unit is electrically connected to the power plug or input terminal, and the last collection unit is electrically connected to the power socket or output terminal, wherein the power plug or input terminal is connected to the power socket or output terminal through a positive electrode connecting wire and a negative electrode connecting wire, wherein one end of the positive electrode connecting wire is connected between the positive electrode of the power plug or input terminal and the first collection unit, and the other end of the positive electrode connecting wire is electrically connected to the power socket or output terminal, wherein one end of the negative electrode connecting wire is electrically connected to the negative electrode of the last collection unit, and the other end of the negative electrode connecting wire is electrically connected to the power plug or input terminal.

2. The return-type wiring structure having multiple devices and units capable of being flexibly increased and decreased of claim 1, wherein the light-emitting device or illuminating device can be an illuminating bulb, an LED lamp, an LED decorative lamp or a lamp bead.

3. The return-type wiring structure having multiple devices and units capable of being flexibly increased and decreased of claim 1, wherein in the collection units, the positive electrodes of the plurality of light-emitting devices or illuminating devices are sequentially connected in parallel, and the negative electrodes of the plurality of light-emitting devices or illuminating devices are sequentially connected in parallel, wherein the positive electrode of the first light-emitting device or illuminating device in the first collection unit is electrically connected to the positive electrode of the power plug or input terminal, and the negative electrode of the last light-emitting device or illuminating device of the last collection unit is electrically connected to the negative electrode connecting wire.

4. The return-type wiring structure having multiple devices and units capable of being flexibly increased and decreased of claim 3, wherein in the total collection unit, all collection units are connected in series through series-connecting the negative electrode of the last light-emitting device or illuminating device of each collection unit with the positive electrode of the first light-emitting device or illuminating device of another collection unit.

5. The return-type wiring structure having multiple devices and units capable of being flexibly increased and decreased of claim of 4, wherein the operating voltage of each collection unit is the operating voltage of each light-emitting device or illuminating device, and the total operating voltage of the total collection unit is the sum of the operating voltages of all collection units.

6. The return-type wiring structure having multiple devices and units capable of being flexibly increased and decreased of claim 1, wherein in the plurality of light-emitting devices or illuminating devices of the connection units, the positive electrode of one light-emitting device or illuminating device is electrically connected to the negative electrode of another light-emitting device or illuminating device, and the negative electrode of one light-emitting device or illuminating device is electrically connected to the positive electrode of another light-emitting device or illuminating device, wherein the positive electrode of the first light-emitting device or illuminating device of the first collection unit is electrically connected to the positive electrode of the power plug or input terminal, and the negative electrode of the last light-emitting device or illuminating device of the last collection unit is electrically connected to the negative electrode connecting wire.

7. The return-type wiring structure having multiple devices and units capable of being flexibly increased and decreased of claim 6, wherein in the total collection unit, the positive electrode of the last light-emitting device or illuminating device of the first collection unit is connected to the positive electrode of the first light-emitting device or illuminating device of the second collection unit in series, and the negative electrode of the last light-emitting device or illuminating device of the second collection unit is connected to the negative electrode of the first light-emitting device or illuminating device of the third collection unit, wherein through alternately series-connecting the positive electrode of the last light-emitting device or illuminating device of each collection unit with the positive electrode of the first light-emitting device or illuminating device of another collection unit, and series-connecting the negative electrode of the last light-emitting device or illuminating device of each collection unit with the negative electrode of the first light-emitting device or illuminating device of another collection unit, the plurality of collection units can be connected in series to form the total collection unit.

8. The return-type wiring structure having multiple devices and units capable of being flexibly increased and decreased of claim 7, wherein the operating voltage of each collection unit is the same as the operating voltage of each light-emitting device or illuminating device, and the total operating voltage of the total collection unit is the sum of the operating voltages of all collection units.

9. The return-type wiring structure having multiple devices and units capable of being flexibly increased and decreased of claim 1, wherein when the number of the collection units is increased from N to N+1, the total operating voltage of the total connection unit is N+1 times that of the operating voltage of a single light-emitting device or illuminating device, and when the number of the collection units is decreased from N to N−1, the total operating voltage of the total connection unit is N−1 times that of the operating voltage of a single light-emitting device or illuminating device.

10. The return-type wiring structure having multiple devices and units capable of being flexibly increased and decreased of claim 1, wherein in each collection unit, when the number of the light-emitting devices or illuminating devices is increased from N to N+1, the operating voltage of the collection unit is the same as the operating voltage of each light-emitting device or illuminating device, and when the number of the light-emitting devices or illuminating device is decreased from N to N−1, the operating voltage of the collection unit is the same as the operating voltage of each light-emitting device or illuminating device.
